(19) United States
(12) Patent Application Publication
(10) Pub. No.: US 2003/0236658 A1
(43) Pub. Date: Dec. 25, 2003

(54) System, method and computer program product for translating information

(76) Inventor: Lloyd Yam, Causeway Bay (HK)

Correspondence Address: SQUIRE, SANDERS & DEMPSEY L.L.P, 600 HANSEN WAY, PALO ALTO, CA, 94304-1043, US

(21) Appl. No.: 10/179,707

(22) Filed: Jun. 24, 2002

(51) Int. Cl. G06F 17/28

(52) U.S. Cl. 704/2

(57) ABSTRACT

A system, method and computer program product are disclosed for translating information from a first language into a second language. Information in a first language is edited to prepare the information for translation into a second language utilizing a first editing module. The information is translated into the second language utilizing a translation module. The translated information is translated to conform the translated information with grammatical rules of the second language utilizing a second editing module.

### FIELD OF THE INVENTION

This invention relates to language translation systems.

### BACKGROUND OF THE INVENTION

When China joins the World Trade Organization, an opportunity of breaking the global recession will be in sight. Western companies will strive to make themselves visible to the Chinese people and translating a few web pages into Chinese would be an excellent start. But when you think about the 300 million web sites lining up behind 100,000 professional translators, you won't be surprised to be told it will take them 5 years to finish these tasks. The world has just been hit by an innocent looking Translation Explosion.

It is estimated that one out of every five people in the world use the Chinese writing system. The Chinese writing system has no alphabet because it was developed before the invention of the alphabet. Thus, words are not represented by combinations of letters. Instead, words are represented by single characters, combinations of two characters, combinations of three characters, and so on. No translation of the written characters is needed between dialects such as Mandarin and Cantonese, because all Chinese dialects use the same written characters with the same meaning, i.e., only the pronunciation of the characters differs.

### SUMMARY Of THE INVENTION

A system, method and computer program product are disclosed for translating information from a first language into a second language. Information in a first language is edited to prepare the information for translation into a second language utilizing a first editing module. The information is translated into the second language utilizing a translation module. The translated information is translated to conform the translated information with grammatical rules of the second language utilizing a second editing module.

In an aspect of the present invention, English may be the first language and Chinese may be the second language. In another aspect, the translated information may be transmitted from the translation module to the second editing module via a network. In such an aspect, the network may be capable of utilizing at least one of: TCP/IP and IPX protocols. In an embodiment of the present invention, the first editing module and the translation module may reside in a first computer while the second editing module resides in a second computer coupled to the first computer by a network.

In one embodiment of the present invention, the editing of the information in the first language to prepare the information for translation into the second language may include rewording idioms, colloquialisms, slang and/or jargon in the information. In another embodiment, the editing of the information in the first language to prepare the information for translation into the second language may include identifying one or more words in the information that have a plurality of definitions, and selecting one of the definitions for each identified word. In such an embodiment, the plurality of definitions may be displayed for each identified word to permit selection of one definition for the identified word from the displayed definitions. In a further embodiment, the editing of the information in the first language to prepare the information for translation into the second language may include deleting one or more words in the information that do not have a corresponding translation in the second language.

In yet another embodiment of the present invention, the editing of the translated information to conform the translated information with grammatical rules of the second language may include transposing one or more words in the translated information to conform the translated information with grammatical rules of the second language. In an additional embodiment, the editing of the translated information to conform the translated information with grammatical rules of the second language may include adding one or more words to the translated information to conform the translated information with grammatical rules of the second language. In another aspect of the present invention, at least a portion of the translating of the information into the second language utilizing the translation module may be carried out during the editing of the information in a first language utilizing the first editing module.

### BRIEF DESCRIPTION OF THE DRAWINGS

FIG. 1 is a flowchart of a process for translating information (e.g., text, characters, and/or textual information) in a first language into a second language in accordance with an embodiment of the present invention;

FIG. 2 is a block diagram of an exemplary translation system for implementing the process set forth in FIG. 1 in accordance with an embodiment of the present invention;

FIG. 3 is a flowchart of a process for editing of the information in the first language utilizing the first editing module to prepare the information for translation into the second language in accordance with an embodiment of the present invention;

FIG. 4 is a flowchart of a process for editing the translated information utilizing the second editing module to conform the translated information with grammatical rules of the second language in accordance with an embodiment of the present invention;

FIG. 5 is a schematic representation of a display for carrying out definition selection by the first editing module in accordance with an embodiment of the present invention;

FIGS. 6A and 6B are a schematic representations of a display for carrying out word deletion utilizing the first editing module in accordance with an embodiment of the present invention;

FIG. 7 is a schematic diagram representing several displays during the performance of word transposition and word addition of an exemplary sentence by the second editing module in accordance with an embodiment of the present invention;

FIG. 8 is a schematic diagram of an illustrative network system with a plurality of components in accordance with an embodiment of the present invention; and

FIG. 9 is a schematic diagram of a representative hardware environment in accordance with an embodiment of the present invention.

### DETAILED DESCRIPTION

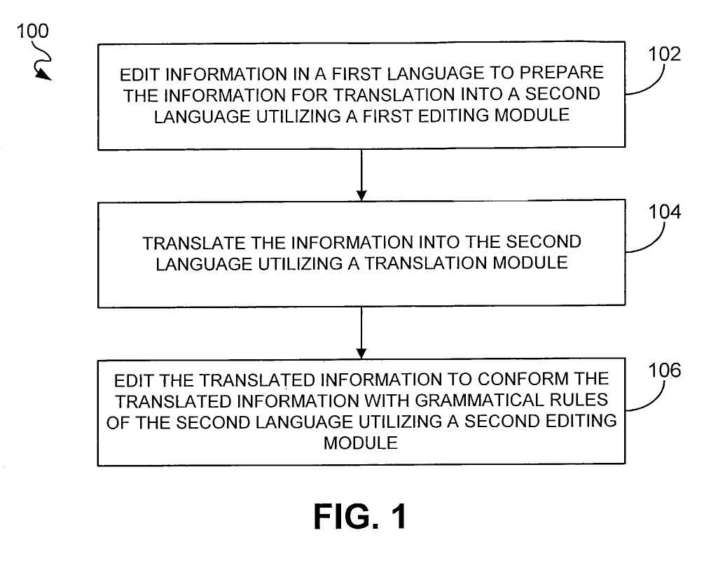

FIG. 1 is a flowchart of a process 100 for translating information (e.g., text, characters, and/or textual information) in a first language into a second language in accordance with an embodiment of the present invention. In operation 102, information in a first language is edited to prepare the information for translation into a second language, preferably by a user fluent in the first language utilizing a first editing module. In operation 104, the information is translated into the second language utilizing a translation module capable of translating information from the first language to the second language. In operation 106, the translated information is edited to conform the translated information with grammatical rules of the second language, preferably by a user fluent in the second language utilizing a second editing module.

In an aspect of the present invention, English may be the first language and Chinese (e.g., Mandarin and/or Cantonese) may be the second language. In another aspect, the translated information may be transmitted from the translation module to the second editing module via a network, such as for example a local access network (LAN), a wide area network (WAN), and/or the Internet. In such an aspect, the network may be capable of utilizing at least one of: TCP/IP and IPX protocols. In an embodiment of the present invention, the first editing module and the translation module may reside in a first computer while the second editing module resides in a second computer coupled to the first computer by a network.

In one embodiment of the present invention, the editing of the information in the first language utilizing the first editing module to prepare the information for translation into the second language may include rewording informal language such as idioms, colloquialisms, slang and/or jargon in the information into more formalized wording and grammar. In another embodiment, the editing of the information in the first language utilizing the first editing module to prepare the information for translation into the second language may include identifying one or more words in the information that have a plurality (i.e., more that one) of definitions or meanings, and selecting one of the definitions for each identified word. In such an embodiment, the plurality of definitions may be displayed for each identified word to permit selection of one definition for the identified word from the displayed definitions. In a further embodiment, the editing of the information in the first language utilizing the first editing module to prepare the information for translation into the second language may include deleting one or more words in the information that do not have a corresponding translation in the second language such as, for example, the articles a, an and the.

In yet another embodiment of the present invention, the editing of the translated information utilizing a second editing module to conform the translated information with grammatical rules of the second language may include transposing (i.e., reordering) one or more words (e.g., individual Chinese characters) in the translated information to conform the translated information with grammatical rules of the second language. In an additional embodiment, the editing of the translated information utilizing a second editing module to conform the translated information with grammatical rules of the second language may include adding one or more words (e.g., individual Chinese characters) to the translated information to conform the translated information with grammatical rules of the second language. In another aspect of the present invention, at least a portion of the translating of the information into the second language utilizing the translation module in operation 104 may be carried out during the editing of the information in a first language utilizing the first editing module in operation 102.

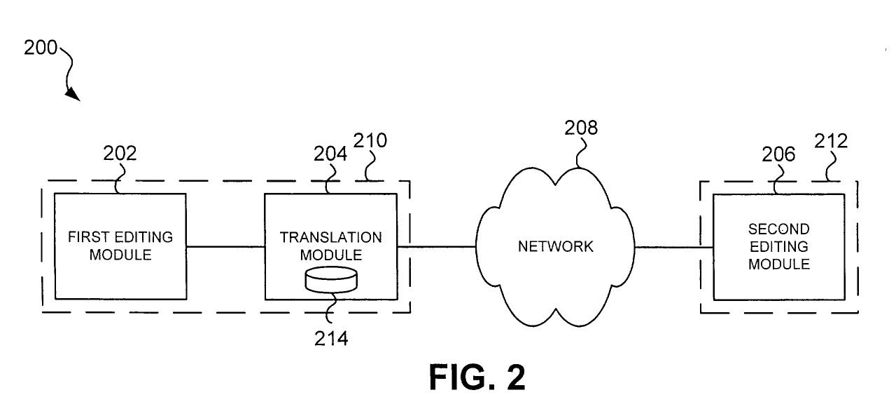

FIG. 2 is a block diagram of an exemplary translation system 200 for implementing the process 100 set forth in FIG. 1 in accordance with an embodiment of the present invention. The translation system 200 includes a first editing module 202 for editing information in a first language to prepare the information for translation into a second language, a translation module 204 for translating the information into the second language, and a second editing module 206 for editing the translated information to conform the translated information with grammatical rules of the second language. The translation module 204 is coupled to the first editing module 202 and the second editing module 206 is coupled to the translation module 204. As illustrated in FIG. 2, in an embodiment of the translation system 200, a network 208 may couple the second editing module 206 to the translation module 204.

With further reference to FIG. 2, the first editing module 202 and the translation module 204 may reside in a first computer 210 while the second editing module may reside in a second computer 212 coupled to the first computer by the network 208 in accordance with an embodiment of the translation system 200. It should also be understood that embodiments of the translation system may include all three modules 202, 204, 206 in a single computer or have each module reside in its own unique computer or have the modules distributed amongst multiple computers that are connected together by the network.

As an option, the translation system 200 may also include a database 214 that is in communication with some or all of the modules 202, 204, 206 of the translation system 200. In one such embodiment, the database may be coupled or included in the translation module 204 as illustrated in FIG. 2.

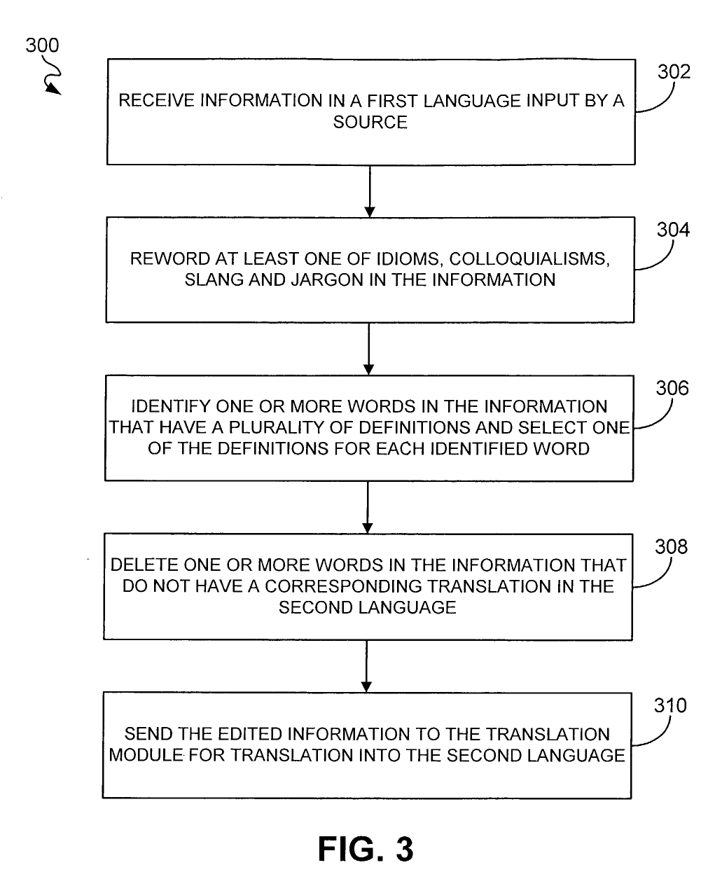

FIG. 3 is a flowchart of a process 300 for editing of the information in the first language utilizing the first editing module 202 to prepare the information for translation into the second language in accordance with an embodiment of the present invention. In operation 302, information in a first language input by a source is received by the first editing module 202. In operation 304, informal language such as idioms, colloquialisms, slang and/or jargon in the information may be reworded into more formalized wording and grammar. In operation 306, one or more words in the information that have a plurality (i.e., more that one) of definitions or meanings may be identified and then one of the definitions for each identified word may be selected. As a further option in operation 306, the plurality of definitions may be displayed for each identified word to permit selection of one definition for the identified word from the displayed definitions. In operation 308, one or more words in the information that do not have a corresponding translation in the second language such as, for example, the articles a, an and the, may be deleted.

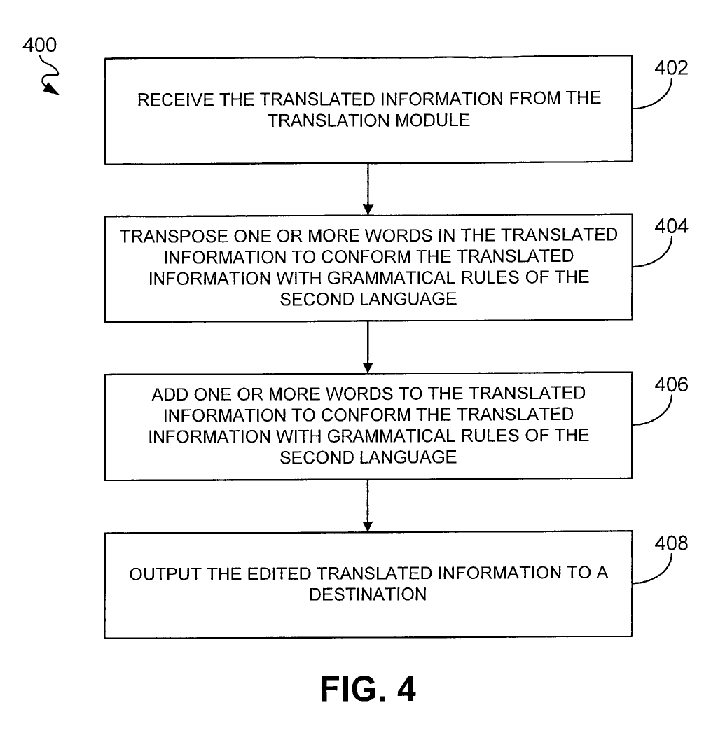

FIG. 4 is a flowchart of a process 400 for editing the translated information utilizing the second editing module 206 to conform the translated information with grammatical rules of the second language in accordance with an embodiment of the present invention. In operation 402, the information that has been translated from the first language to the second language by the translation module 204 (i.e., the translated information) is received from the translation module 204 by the second editing module 206. In operation 404, one or more words (e.g., individual Chinese characters) in the translated information may be transposed (i.e., reordered) to conform the translated information with grammatical rules of the second language. In operation 406, one or more words (e.g., individual Chinese characters) may be added to the translated information to conform the translated information with grammatical rules of the second language. The edited translated information may then be output from the second editing module 206 to a destination for use by the destination.

The following portion of the description sets forth various exemplary and illustrative aspects of the present invention.

In accordance with an embodiment of the present invention, each piece of English text may be handled by two persons. An English-speaking guy, who knows nothing about Chinese, uses the special software to translate English into Chinese. Then, the Chinese guy, who knows nothing about English, edits the Chinese text to make reading easy. Why these guys? Because there are many Americans who don't know Chinese, and there are even more Chinese who don't know English.

The English language comprehending translator may have to do several tasks. Even with artificial intelligence, translation software in the market may not be able pick the correct meaning out of several definitions. So word selection may be one of the tasks. For example, the word “close” in the phrase, “close friends” has several Chinese translations. For example, “close” may mean “shut”, as in “shut the door” and “intimate”, as in “intimate friends”. Thus, the second meaning should be selected. Without any knowledge of Chinese, the English translator may be able to select the right definition because it's got “intimate” after it.

As another illustrative example, for the word “Chinese” in a sentence, the translation system may identify three definitions for this term. As a result, the first editing module may display the three definitions to the English translator with corresponding the Chinese characters adjacent to the definition as follows.

Term: “Chinese”

Possible Definitions:

[symbol] people

[symbol] language

[symbol] adjective

When he translates “She studied Chinese at an early age” he picks the second definition, “language” that gives him the Chinese character: [symbol] not only for the reason that it makes sense, but also that the other two definitions are obvious misfits.

Two more examples are given below to show that short hints may be adequate to the user:

Term: Drown

Possible Definitions:

[symbol] people

[symbol] sound

[symbol] sorrows

Term: Medicine

Possible Definitions:

[symbol] drug

[symbol] study

Such short definition may lend themselves for use in applications running on portable devices such as mobile phones and PDA's. Also, economizing memory, processing power and data transmission may also be important in such applications. In one embodiment, there may not be a need for Chinese representations of the word to be there. Just codes would suffice—and you don't even need the Chinese characters to perform this translation task.

The another task of the English translator is to rewrite part of a sentence before running the translation software. It happens occasionally that phrases and idioms are not recognized by the dictionary. For example, a sentence like “This is only the tip of the iceberg” should be replaced by “This is only one of many such problems” or “There are more problems of this kind”. If you leave a word like “iceberg” to the automatic translation engine, its Chinese version could be a total bewilderment to the Chinese translator.

A process of English to Chinese translation may comprise eight steps known as: repetition, amplification, omission, conversion, inversion, negation, division and change of voices. Embodiments of the present invention allocate the tasks of these eight steps into three groups so that: a first group that may take care of tasks which can be performed by an English speaking person who knows no Chinese, a second group (which may be implemented by software) that may take care of tasks that can be automated without ambiguity, and a third group which may take care of tasks which can be performed by a Chinese speaking person who knows no English. Thus, the first group may perform word selection and paraphrasing, the third group may perform rearrangement of Chinese texts with some editing, and the second group may perform verbatim translation, a limited amount of Artificial Intelligence and provide a user-friendly interface to avoid Chinese Input.

Good translation may involves transposition, that is, re-arrangement of Chinese words and phrases. My research has established a correlation between English words and the Transposition Modes, see FIG. 1. Thus, using just a number to represent the Transposition Mode and storing it in the dictionary database achieves quality translation without memory penalties. The Japanese method has no guidance on transposition.

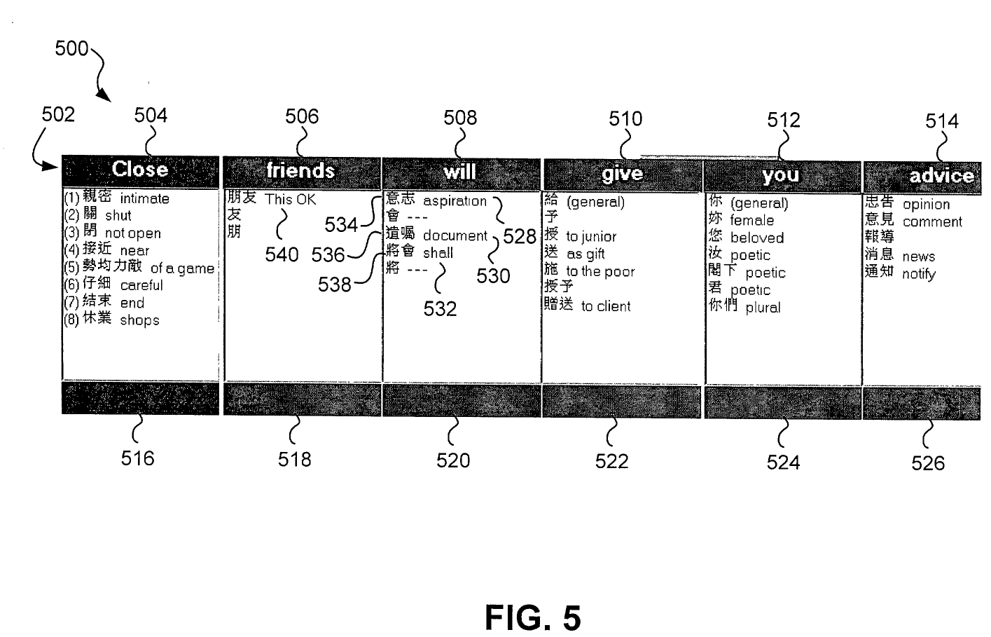

FIG. 5 is a schematic representation of a display 500 for carrying out definition selection by the first editing module 202 in accordance with an embodiment of the present invention. FIG. 5 illustrates an exemplary sentence/phrase 502 displayed by the first editing module 202 of that identifies words in a sentence having multiple definitions in accordance with an embodiment of the present invention. In one embodiment, the first editing module may parse the input textual information into sentences and then display one sentence at a time with the word identified as having more than one definition and their associated definitions. The exemplary sentence 502 displayed in FIG. 5 is “Close friends will give you advice.” The exemplary sentence is in the first language, which in this case is English.

Beneath each word (words 504-514) is a column of definitions (definition columns 516-526) associated with the particular word. As shown in FIG. 5, displayed in the columns of those words which the first editing module has identified as having multiple definitions (e.g., words 504, and 508-512) are each of the associated definitions. For example, under the word “will” 508, the related definitions “aspiration” 528, “document” 530, and “shall” 532 are displayed in associated column 518.

In the embodiment illustrated in FIG. 5, adjacent each definition in English (e.g., definitions 528-532) may be the corresponding Chinese character(s)/word(s) (e.g., Chinese characters 534-538) that have the same or similar meaning. In one embodiment of the present invention, these Chinese translations of the definitions may be generated/provided by the translation module 204. Under words having only one definition (e.g., the word “friends” 506), the associated column (e.g., definition column 518 may include an indication 540 (e.g., “This is OK) that the appropriate definition for the word has already been identified.

The user's task is to select a Chinese definition for each of the displayed English words and then the computer will arrange the Chinese in the same order from left to right, for example, starting with the definition of “close” 504 and finishing with the definition of “advice” 512. The English translation assistant starts with “close” and observes there are eight possibilities. When combined with the next word “friends”, only the first definition, with the hint “intimate”, makes sense. Hence he clicks the first line and the translation module provides the appropriate Chinese translation for the definition of the word and may display the Chinese character/word in the box at the bottom of the appropriate column (e.g., box 514 for the word close 504). Once the definitions have been selected for each of the English words, the resulting Chinese characters may be displayed in the boxes in the bottom is a rough translation of the English sentence in accordance with an embodiment of the present invention.

Thus in general, for each word in the English sentence, the user selects one definition for each word, and the result is a Chinese sentence in the columns at the bottom of the column. A departure from this rule is: when “This OK” or “general” appears in the definitions, the computer will automatically make the selection. The rationale is that “friends” and “give” can be given a single Chinese definition without ambiguity.

Associated words and phrases may also be used in embodiments of the present invention during the translation process. These associations may be used to achieve a better translation but are not part of the definition of the word. For example, “If I were you, I would not go” is first translated into [symbol] [symbol] but the character [symbol] should be added for better reading and comprehension by a Chinese reader so that the final translated phrase is: [symbol] [symbol] . Here, [symbol] is not a definition of the English work “if” but enhances the quality of the result. In one embodiment of the present invention, associations may be activated through the use of Function Keys. With function keys, Chinese Input may be eliminated if the need arises for a particular application or implementation.

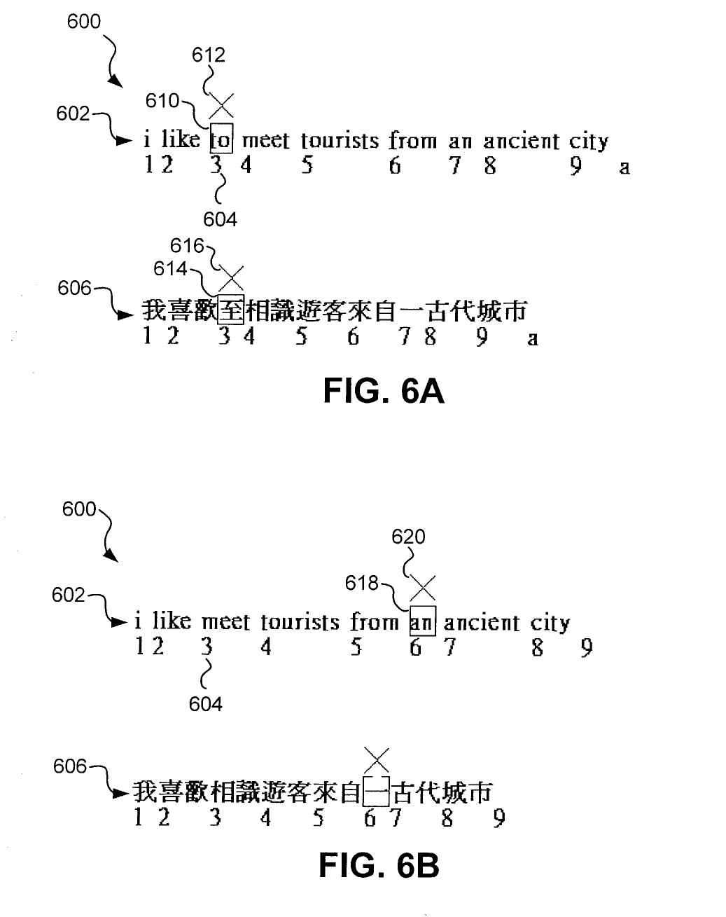

FIGS. 6A and 6B are a schematic representations of a display 600 for carrying out word deletion utilizing the first editing module 202 in accordance with an embodiment of the present invention. In this embodiment, the translation of the words by the translation module may have already been performed during definition selection. The display includes a sentence in the first language 602 on which word deletion may be performed. In the example illustrated in FIGS. 6A and 6B, the exemplary sentence 602 is the English sentence, “I like to meet tourists from the ancient city.” Adjacent each word of the sentence 602 is a number (e.g., number 604). As a further option, the translation system may also display Chinese language version of the sentence 606 with numbers (e.g., number 608) adjacent each appropriate character(s). The numbers may be automatically assigned by the translation system to facilitate editing by a user. The translation system may also identify words in the English sentence 602 for deletion such as the word “to” by highlighting the word in some manner such as by a box 610 around the word and positioning a cross 612 adjacent the highlighted word to suggest its deletion to the user. As an option, the corresponding Chinese character(s) in the Chinese sentence 606 may also be highlighted in a similar fashion (see box 614 and cross 616). The user may also be asked to make a decision as to whether to delete or keep the highlighted word in the sentence such as by being prompted to press the ENTER key to delete or press Esc key to keep.

If the user decides to delete the rhighlighter word (such as, for example selecting the ENTER key), the translation system redisplays the sentence with the highlighted word deleted as illustrated in FIG. 6B. As an option, the words of the sentence may be renumbered as illustrated in FIG. 6B. FIG. 6B also illustrates the translation system highlighting the word “an” (see box 618 and cross 620) to suggest that this word should also be deleted. When the translation system has finished suggesting words for deletion and the user has selected which highlighted words to delete, the resulting Chinese sentence may be the end of the English language-comprehending translator's task. This Chinese sentence may then be forwarded to the second editing module for further editing by a Chinese language-comprehending translator. This may be carried by translating the sentence via a network such as the Internet and may even be sent in an email message.

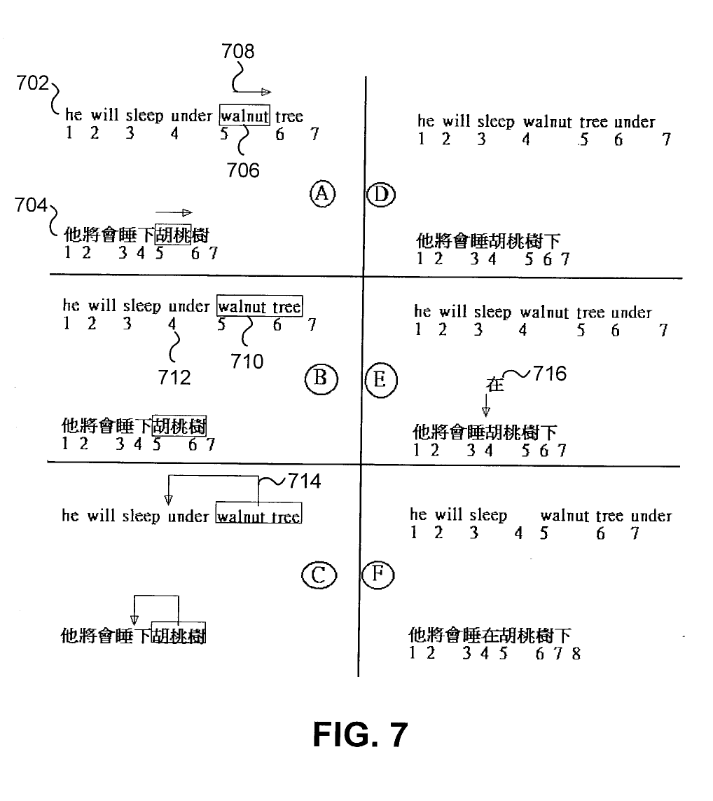

FIG. 7 is a schematic diagram representing several displays during the performance of word transposition and word addition of an exemplary sentence by the second editing module in accordance with an embodiment of the present invention. In FIG. 7, the displays are labeled A through F to indicate the chronology in which they are displayed with display A being displayed first and display F being displayed last. In display A, the translation system displays (preferably to the Chinese language-comprehending translator) the English sentence 702 and its corresponding Chinese translation 704 received from the first editing module and the translation module. As in the embodiment illustrated in FIGS. 6A and 6B, each of the words/characters in the respective sentences may be numbered for ease of reference and identification during editing with the second editing module. In the exemplary sentence, the translation system identifies/highlights the word “under” and instructs the user to group some words immediately on the right side of “under”. The box 706 and arrow 708 may be displayed automatically and a message may be displayed to instruct the user carry out the word transposition. For example, the translation system may display the instruction: “Press the right arrow key to collect a word group. Then press a number to indicate the position of insertion.” In other words, moving “walnut” alone makes no sense, but moving “walnut tree” does. Hence her first action is pressing the arrow key once. The translation system responds as shown in display B with the two words highlighted together 710.

The Chinese language comprehending user may then decide where to re-insert this group in the sentence—the user's second action. The Chinese language comprehending user knows that in the Chinese language, these two words would best be positioned before the word “under” and so she selects the number “4” 712 to indicate the location of the re-insertion. The translation system then generates display C showing the path 714 of the re-insertion and then the final result with the re-insertion carried out in display D. Thus, with very simple commands, the Chinese language comprehending user has carried out word transposition with the second editing module of the translation system. In the illustrative scenario set forth in FIG. 7, all the Chinese language comprehending user did was a single press of an arrow key and one press of the number 4 key: the translation system did all the graphics and displayed the results of the user's actions.

With continuing reference to FIG. 7, in the database 214, the word “under” may be associated with the Chinese word [symbol] . After the transposition, the translation system may suggest the addition of this Chinese word. However, the location in the sentence where this word is to be inserted may be left to the Chinese language comprehending translator. The translator's knowledge of Chinese may allow the translator to know where to insert the word. In the illustrative example, the added word should go before the characters representing walnut tree (i.e., adjacent the number “4”) and so the translator should select the number “4.” The translation system responds as shown in displays E and F by indicating the location that the added word 716 is to be inserted in display E and the resulting sentence in display F.

In an embodiment of the present invention, the database 214 may be described as containing the following information:

1. What information may be attached to each English word?—Up to 8 Chinese definitions

2. For each Chinese definition, there may be an English phrase (hint)

3. One integer (that is, a number) designated as the Editing Code. This code helps identify whether the word should be deleted, or rearrangement will be involved, or no action is required. For rearrangement, the way words should be transposed may be defined by the value of the code. There are transposition algorithms in the translation system which generate instruction and graphical display to the user to perform the re-arrangement.

4. Up to 2 Chinese phrases which can be added to the sentence to make better reading. These may be known as associated words. For illustration, although there is no equivalent in English, one close example is in “I'm not cold”. The word “not” is associated with “at all”. In some context, it is better to say “I'm not cold at all.”

For the English language comprehending translator, (1) and (2) of the above list plus deletion may be utilized. For the Chinese language comprehending translator, (3) minus deletion and (4) of the above list may be utilized.

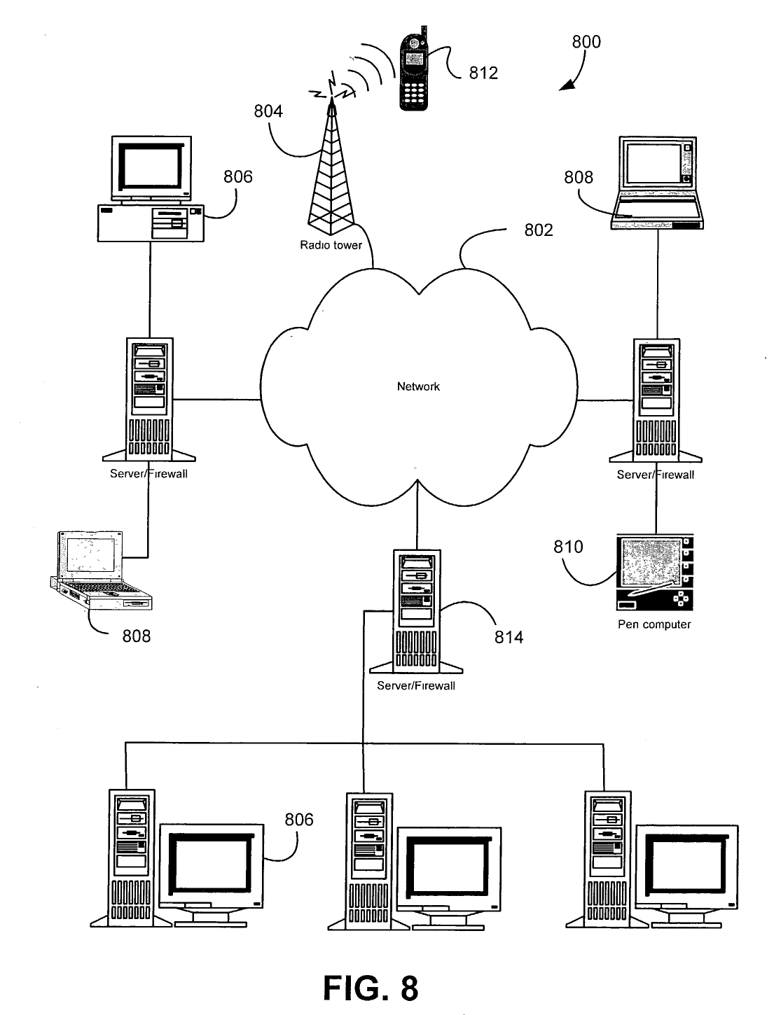

FIG. 8 illustrates an exemplary network system 800 with a plurality of components in accordance with one embodiment of the present invention. As shown, such components include a network 802 which take any form including, but not limited to a local area network, a wide area network such as the Internet, and a wireless network 804. Coupled to the network 802 is a plurality of computers which may take the form of desktop computers 806, lap-top computers 808, hand-held computers 810 (including wireless devices 812 such as wireless PDA's or mobile phones), or any other type of computing hardware/software. As an option, the various computers may be connected to the network 802 by way of a server 814 which may be equipped with a firewall for security purposes. It should be noted that any other type of hardware or software may be included in the system and be considered a component thereof.

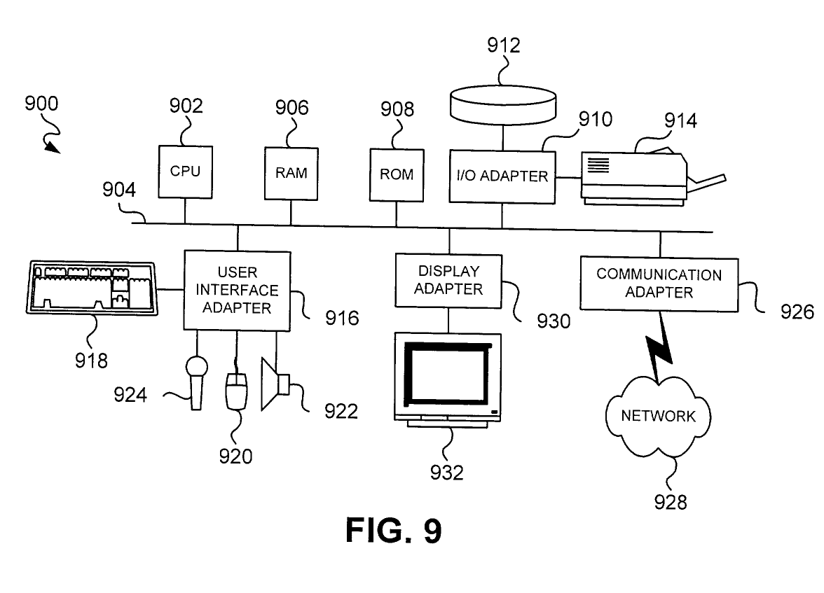

A representative hardware environment associated with the various components of FIG. 8 is depicted in FIG. 9. In the present description, the various sub-components of each of the components may also be considered components of the system. For example, particular software modules executed on any component of the system may also be considered components of the system. In particular, FIG. 9 illustrates an exemplary hardware configuration of a workstation 900 having a central processing unit 902, such as a microprocessor, and a number of other units interconnected via a system bus 904.

The workstation shown in FIG. 9 includes a Random Access Memory (RAM) 906, Read Only Memory (ROM) 908, an I/O adapter 910 for connecting peripheral devices such as, for example, disk storage units 912 and printers 914 to the bus 904, a user interface adapter 916 for connecting various user interface devices such as, for example, a keyboard 918, a mouse 920, a speaker 922, a microphone 924, and/or other user interface devices such as a touch screen or a digital camera to the bus 904, a communication adapter 926 for connecting the workstation 900 to a communication network 928 (e.g., a data processing network) and a display adapter 930 for connecting the bus 904 to a display device 932. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may also be written using Java, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in-object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. An embodiment of the invention utilizes HyperText Markup Language (HTML) to implement documents on the Internet together with a general-purpose secure communication protocol for a transport medium between the client and the server. HTTP or other protocols could be readily substituted for HTML without undue experimentation. Information on these products is available in T. Berners-Lee, D. Connoly, “RFC 1866: Hypertext Markup Language-2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created. Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

JavaScript is an interpreted programming or script language from Netscape. It is somewhat similar in capability to Microsoft's Visual Basic, Sun's Tcl, the UNIX-derived Perl, and IBM's REX. In general, script languages are easier and faster to code in than the more structured and compiled languages such as C and C++. JavaScript is used in Web site development to do such things as: automatically change a formatted date on a Web page; cause a linked-to page to appear in a popup window; and cause text or a graphic image to change during a mouse rollover.

JavaScript uses some of the same ideas found in Java. JavaScript code can be imbedded in HTML pages and interpreted by the Web browser (or client). JavaScript can also be run at the server as in Microsoft's Active Server Pages before the page is sent to the requestor. Both Microsoft and Netscape browsers support JavaScript.

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

A technology of Active X is the component object model (COM). Used in a network with a directory and additional support, COM becomes the distributed component object model (DCOM). The main thing that you create when writing a program to run in the ActiveX environment is a component, a self-sufficient program that can be run anywhere in your ActiveX network. This component is known as an ActiveX control. ActiveX is Microsoft's answer to the Java technology from Sun Microsystems. An ActiveX control is roughly equivalent to a Java applet.

OCX stands for “Object Linking and Embedding control.” Object Linking and Embedding (OLE) was Microsoft's program technology for supporting compound documents such as the Windows desktop. The Component Object Model now takes in OLE as part of a larger concept. Microsoft now uses the term “ActiveX control” instead of “OCX” for the component object.

An advantage of a component is that it can be re-used by many applications (referred to as component containers). A COM component object (ActiveX control) can be created using one of several languages or development tools, including C++ and Visual Basic, or PowerBuilder, or with scripting tools such as VBScript.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.” Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Early experimenters in electromagnetic physics dreamed of building a so-called wireless telegraph The first wireless telegraph transmitters went on the air in the early years of the 20th century. Later, as amplitude modulation (AM) made it possible to transmit voices and music via wireless, the medium came to be called radio. With the advent of television, fax, data communication, and the effective use of a larger portion of the electromagnetic spectrum, the original term has been brought to life again.

Common examples of wireless equipment in use today include the Global Positioning System, cellular telephone phones and pagers, cordless computer accessories (for example, the cordless mouse), home-entertainment-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can be presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Encryption is the conversion of data into a form, called a ciphertext, that cannot be easily understood by unauthorized people. Decryption is the process of converting encrypted data back into its original form, so it can be understood.

The use of encryption/decryption is as old as the art of communication. In wartime, a cipher, often incorrectly called a “code,” can be employed to keep the enemy from obtaining the contents of transmissions (technically, a code is a means of representing a signal without the intent of keeping it secret; examples are Morse code and ASCII). Simple ciphers include the substitution of letters for numbers, the rotation of letters in the alphabet, and the “scrambling” of voice signals by inverting the sideband frequencies. More complex ciphers work according to sophisticated computer algorithm that rearrange the data bits in digital signals.

In order to easily recover the contents of an encrypted signal, the correct decryption key is required. The key is an algorithm that “undoes” the work of the encryption algorithm. Alternatively, a computer can be used in an attempt to “break” the cipher. The more complex the encryption algorithm, the more difficult it becomes to eavesdrop on the communications without access to the key.

Rivest-Shamir-Adleman (RSA) is an Internet encryption and authentication system that uses an algorithm developed in 1977 by Ron Rivest, Adi Shamir, and Leonard Adleman.

The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet.

The private key is used to decrypt text that has been encrypted with the public key. Thus, if I send you a message, I can find out your public key (but not your private key) from a central administrator and encrypt a message to you using your public key. When you receive it, you decrypt it with your private key. In addition to encrypting messages (which ensures privacy), you can authenticate yourself to me (so I know that it is really you who sent the message) by using your private key to encrypt a digital certificate. When I receive it, I can use your public key to decrypt it.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface.

On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. Initially, the Netscape browser allowed you to download, install, and define supplementary programs that played sound or motion video or performed other functions. These were called helper applications. However, these applications run as a separate application and require that a second window be opened. A plug-in application is recognized automatically by the browser and its function is integrated into the main HTML file that is being presented.

A browser is an application program that provides a way to look at and interact with all the information on the World Wide Web. The word “browser” seems to have originated prior to the Web as a generic term for user interfaces that let you browse (navigate through and read) text files online. By the time the first Web browser with a GUI was generally available (Mosaic, in 1993), the term seemed to apply to Web content, too. Technically, a Web browser may be considered a client program that uses the Hypertext Transfer Protocol (HTTP) to make requests of Web servers throughout the Internet on behalf of the browser user. Many of the user interface features in Mosaic, however, went into the first widely-used browser, Netscape Navigator. Microsoft followed with its Microsoft Internet Explorer. Lynx is a text-only browser for UNIX shell and VMS users. Another browser is Opera. While some browsers also support e-mail (indirectly through e-mail Web sites) and the File Transfer Protocol (FTP), a Web browser may not be required for those Internet protocols and more specialized client programs are more popular.

Hashing is the transformation of a string of characters into a usually shorter fixed-length value or key that represents the original string. Hashing may be used to index and retrieve items in a database because it is faster to find the item using the shorter hashed key than to find it using the original value. It may also used in encryption algorithms. A hashing algorithm is called the hash function. Hashing may also used to encrypt and decrypt digital signatures (used to authenticate message senders and receivers). The digital signature is transformed with the hash function and then both the hashed value (known as a message-digest) and the signature are sent in separate transmissions to the receiver. Using the same hash function as the sender, the receiver derives a message-digest from the signature and compares it with the message-digest it also received. They should be the same. The hash function may be used to index the original value or key and then used later each time the data associated with the value or key is to be retrieved. Thus, hashing is always a one-way operation. There's no need to “reverse engineer” the hash function by analyzing the hashed values. In fact, the ideal hash function can't be derived by such analysis. A good hash function also should not produce the same hash value from two different inputs. If it does, this is known as a collision. A hash function that offers an extremely low risk of collision may be considered acceptable. Some exemplary hash functions include the division-remainder method, the folding method, the radix transformation method and the digit rearrangement method. In the division-remainder method, the size of the number of items in the table is estimated. That number is then used as a divisor into each original value or key to extract a quotient and a remainder. The remainder is the hashed value. The folding method divides the original value into several parts, adds the parts together, and then uses the last four digits (or some other arbitrary number of digits) as the hashed value or key. The radix transformation method may be utilized where the value or key is digital. In this method, the number base (or radix) can be changed resulting in a different sequence of digits. For example, a decimal numbered key could be transformed into a hexadecimal numbered key. High-order digits can be discarded to fit a hash value of uniform length. The digit rearrangement method is simply the taking of part of the original value or key such as digits in positions 3 through 6, reversing their order, and then using that sequence of digits as the hash value or key.

A hash function that works well for database storage and retrieval might not work as for cryptographic or error-checking purposes. There are several well-known hash functions used in cryptography. These include the message-digest hash functions MD2, MD4, and MD5, used for hashing digital signatures into a shorter value called a message-digest, and the Secure Hash Algorithm (SHA), a standard algorithm, that makes a larger (60-bit) message digest and is similar to MD4. U.S. Pat. No. 4,309,569 issued Jan. 5, 1982 to Ralph Merkle and entitled, “Method of providing digital signatures” and incorporated herein by reference describes a use of hash functions to build trees in order to authenticate an item in a list of items.

A timestamp may be an identifier for transaction that may be used to permit ordering. A timestamp may also be used to verify digital signatures and help reduce the possibility that someone will derive a private key from the public key in a digital certificate. In order to reduce the possibility that someone will derive a private key from the public key in a digital certificate, the certifying authority may issue the key pair with an expiration date so that they must be replaced periodically. Any signature applied after the digital certificate expires is invalid. To assure that a signature was applied before the certificate expired, the certifying authority can timestamp a digital signature. Essentially, that means taking the signature, adding the current time and signing them together. When a digital signature is timestamped in this way, the software can verify that the signature was applied while the certificate was still valid. U.S. Pat. No. 5,136,647 issued to S. A: Haber et al. on Aug. 4, 1992, entitled “Method for secure timestamping of digital documents” is incorporated herein by reference and discloses a variety of technological and algorithmic components of digital timestamping including the linking of timestamp requests in a sequence, a random-witness method that uses the document being timestamped to pseudo-randomly choose timestamping witnesses, the use of a single hash value to represent a timestamp request for an accumulation or collection of digital documents, and a time-stamping process that does not explicitly require the use of a digital signature.

U.S. Pat. No. 5,373,561 issued to S. A. Haber et al. on Dec. 13, 1994, entitled “Method of extending the validity of a cryptographic certificate” is incorporated by reference herein and discloses a use of timestamping to renew or to extend the validity of cryptographic certifications of authenticity such as timestamp certificates and digital signatures. This use enables a digitally signed record to retain its validity even if the signer's private key is later compromised, or the key's digital certificate has expired. As long as the timestamp for the record indicates that it was signed prior to the compromise of the key, or during the digital certificate's validity period, the signature is still trustworthy. This patent also discloses a parallel use of multiple hash functions in a timestamping system.

The Secure Sockets Layer (SSL) is a commonly-used protocol for managing the security of a message transmission on the Internet. SSL has recently been succeeded by Transport Layer Security (TLS), which is based on SSL. SSL uses a program layer located between the Internet's Hypertext Transfer Protocol (HTTP) and Transport Control Protocol (TCP) layers. SSL is included as part of both the Microsoft and Netscape browsers and most Web server products. Developed by Netscape, SSL also gained the support of Microsoft and other Internet client/server developers as well and became the de facto standard until evolving into Transport Layer Security. The “sockets” part of the term refers to the sockets method of passing data back and forth between a client and a server program in a network or between program layers in the same computer. SSL uses the public-and-private key encryption system from RSA, which also includes the use of a digital certificate.

TLS and SSL are an integral part of most Web browsers (clients) and Web servers. If a Web site is on a server that supports SSL, SSL can be enabled and specific Web pages can be identified as requiring SSL access. Any Web server can be enabled by using Netscape's SSLRef program library which can be downloaded for noncommercial use or licensed for commercial use. TLS and SSL are not interoperable. However, a message sent with TLS can be handled by a client that handles SSL but not TLS.

A SSL protocol is described in the SSL Protocol Version 3.0 by the Transport Layer Security Working Group, Nov. 18, 1996 for providing communications privacy over the Internet and allowing client/server applications to communicate in a way that is designed to prevent eavesdropping, tampering, or message forgery, the disclosure of which is incorporated herein by reference in its entirety.

Transport Layer Security (TLS) is a protocol that ensures privacy between communicating applications and their users on the Internet. When a server and client communicate, TLS ensures that no third party may eavesdrop or tamper with any message. TLS is a successor to the Secure Sockets Layer (SSL). TLS is composed of two layers: the TLS Record Protocol and the TLS Handshake Protocol. The TLS Record Protocol provides connection security with some encryption method such as the Data Encryption Standard (DES). The TLS Record Protocol can also be used without encryption. The TLS Handshake Protocol allows the server and client to authenticate each other and to negotiate an encryption algorithm and cryptographic keys before data is exchanged. The TLS protocol is based on Netscape's SSL 3.0 protocol; however, TLS and SSL are not interoperable. The TLS protocol does contain a mechanism that allows TLS implementation to back down to SSL 3.0. A TLS protocol is described in the document entitled, “The TLS Protocol, Version 1” by the Network Working Group of the Internet Society, 1999, the disclosure of which is incorporated herein by reference in its entirety. This document specifies Version 1.0 of the Transport Layer Security (TLS) protocol. The TLS protocol provides communications privacy over the Internet. The protocol allows client/server applications to communicate in a way that is designed to prevent eavesdropping, tampering, or message forgery.

Wireless Transport Layer Security (WTLS) is the security level for Wireless Application Protocol (WAP) applications. Based on Transport Layer Security (TLS) v1.0 (a security layer used in the Internet, equivalent to Secure Socket Layer 3.1), WTLS was developed to address the problematic issues surrounding mobile network devices—such as limited processing power and memory capacity, and low bandwidth—and to provide adequate authentication, data integrity, and privacy protection mechanisms.

Wireless transactions, such as those between a user and their bank, require stringent authentication and encryption to ensure security to protect the communication from attack during data transmission. Because mobile networks do not provide end-to-end security, TLS had to be modified to address the special needs of wireless users. Designed to support datagrams in a high latency, low bandwidth environment, WTLS provides an optimized handshake through dynamic key refreshing, which allows encryption keys to be regularly updated during a secure session.

The Wired Equivalent Privacy (WEP) algorithm, is part of the 802.11 standard. The 802.11 standard describes the communication that occurs in wireless local area networks (LANs). The Wired Equivalent Privacy (WEP) algorithm is used to protect wireless communication from eavesdropping. A secondary function of WEP is to prevent unauthorized access to a wireless network; this function is not an explicit goal in the 802.11 standard, but it is frequently considered to be a feature of WEP. WEP relies on a secret key that is shared between a mobile station (e.g. a laptop with a wireless Ethernet card) and an access point (i.e. a base station). The secret key is used to encrypt packets before they are transmitted, and an integrity check is used to ensure that packets are not modified in transit. The standard does not discuss how the shared key is established. In practice, most installations use a single key that is shared between all mobile stations and access points.

U.S. Pat. No. 4,791,587 to Doi entitled, “System for translation of sentences from one language to another” relates to English to Japanese translation and is incorporated herein by reference. Its invention helps the definition selection process. After the user makes a selection, the computer remembers that selection. In subsequent operations, when the same word or some combination is encountered, the computer will display the “best guess” at the top of the list.

U.S. Pat. No. 4,787,038 to Doi entitled, “Machine translation system” relates to English to Japanese translation and is incorporated herein by reference. Its invention helps the definition selection process. It makes use of parts of speech as described above. In addition to the display of multiple definitions, it shows processing units. These units show new definitions not contained in the first display and are given class names. These names are supposed to help the user in making definition selections. U.S. Pat. No. 5,373,441 to Hirai entitled, “Automatic translating apparatus and a method thereof” relates to English to Japanese translation and is incorporated herein by reference. Its invention helps the definition selection process. It prepares the original sentence by analyzing the parts of speech of each word (whether it is a verb, a noun, and so on). It then selects the definition automatically from the dictionary based on the part of speech thus determined. Rules are formulated to deal with auxiliary verbs such as must, would, may, and so on which often cause problems in English-to-Japanese translation.

U.S. Pat. No. 5,541,837 to Fushimoto entitled, “Method and apparatus for further translating result of translation” relates to a translation apparatus that handles many languages and is incorporated herein by reference.

U.S. Pat. No. 5,224,040 to J. T. Tou entitled, “Method for translating Chinese sentences” is incorporated by reference herein. This patent discloses a translation system where a character string of a Chinese sentence is input into the memory of a personal computer, and the first six characters of the sentence are taken from that memory and placed in a main buffer. A segment processor fetches the first three of those six characters from the main buffer and puts them into a trio buffer. The segment processor then fetches the first character from the trio buffer to match with the number dictionary. This process is continued until consecutive number characters are identified. If the first character is not a number word, the segment processor uses the three characters in the trio buffer and the segmentation program and logic to search for matched name words and regular words stored in dictionaries within the hard disk memory of the computer. The identified words are treated as candidate words and are successively sent from the computer to the word buffer for further study. The segmentation processor then applies additional sophisticated rules and logic to select meaningful words from the candidates in the word buffer, and grouped words are delivered to an output buffer. The computer fetches those words, performs the final translation by making use of translation rules and logic, and displays the translation in the preselected target language.

U.S. Pat. No. 6,151,570 to Fuji entitled, “Translating apparatus, dictionary search apparatus, and translating method” describes a translating apparatus, a dictionary search apparatus, and a translating method for translating a portion of a document efficiently and accurately and is incorporated by reference herein.

______Patent No. 152,763 to______relates to English to Japanese translation and is incorporated herein by reference. Its invention helps the definition selection process. It looks at adjacent words in the original text before translation is carried out. The database contains phrases for matching accordingly. It also puts selection in the memory and identifies identical phrases in the subsequent operation. The same translation will be selected when identical phrases are encountered.

______Patent No. 175802 to______relates to Chinese to Japanese translation and is incorporated herein by reference. It requires Chinese to be entered on the keyboard for translation.

PCT Publication WO 97/4045 to______relates to Japanese to English translation and is incorporated herein by reference. The invention makes it possible to re-translate part of the sentence automatically if the first round of translation is unacceptable.

It will thus be seen that the objects set forth above, and those made apparent from the foregoing description, are efficiently attained and since certain changes can be made in the above description without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for translating, comprising:
a) editing information in a first language to prepare the information for translation into a second language utilizing a first editing module;
b) translating the information into the second language utilizing a translation module; and
c) editing the translated information to conform the translated information with grammatical rules of the second language utilizing a second editing module.

2. The method of claim 1, wherein English is the first language and Chinese is the second language.

3. The method of claim 1, wherein the translated information is transmitted from the translation module to the second editing module via a network.

4. The method of claim 3, wherein the network is capable of utilizing at least one of: TCP/IP and IPX protocols.

5. The method of claim 3, wherein the first editing module and the translation module reside in a first computer and the second editing module resides in a second computer coupled to the first computer by the network.

6. The method of claim 1, wherein editing information in the first language to prepare the information for translation into the second language comprises rewording at least one of idioms, colloquialisms, slang and jargon in the information.

7. The method of claim 1, wherein editing information in the first language to prepare the information for translation into the second language comprises identifying one or more words in the information that have a plurality of definitions, and selecting one of the definitions for each identified word.

8. The method of claim 7, further comprising displaying the plurality of definitions for at least one of the identified words to permit selection of the one definition for the identified word from the displayed definitions.

9. The method of claim 1, wherein editing information in the first language to prepare the information for translation into the second language comprises deleting one or more words in the information that do not have a corresponding translation in the second language.

10. The method of claim 1, wherein editing the translated information to conform the translated information with grammatical rules of the second language comprises transposing one or more words in the translated information to conform the translated information with grammatical rules of the second language.

11. The method of claim 1, wherein editing the translated information to conform the translated information with grammatical rules of the second language comprises adding one or more words to the translated information to conform the translated information with grammatical rules of the second language.

12. The method of claim 1, wherein at least a portion of the translating of the information into the second language utilizing the translation module is carried out during the editing of the information in a first language utilizing the first editing module.

13. A system for translating, comprising:
a) a first editing module for editing information in a first language to prepare the information for translation into a second language;
b) a translation module for translating the information into the second language, the translation module being coupled to the first editing module; and
c) a second editing module for editing the translated information to conform the translated information with grammatical rules of the second language, the second editing module being coupled to the translation module.

14. The system of claim 13, wherein English is the first language and Chinese is the second language.

15. The system of claim 13, wherein editing information in the first language to prepare the information for translation into the second language comprises: rewording at least one of idioms, colloquialisms, slang and jargon in the information; identifying one or more words in the information that have a plurality of definitions; selecting one of the definitions for each identified word; and deleting one or more words in the information that do not have a corresponding translation in the second language.

16. The system of claim 13, wherein editing the translated information to conform the translated information with grammatical rules of the second language comprises: transposing one or more words in the translated information to conform the translated information with grammatical rules of the second language; and adding one or more words to the translated information to conform the translated information with grammatical rules of the second language.

17. A computer program product for translating, comprising:
a) computer code for editing information in a first language to prepare the information for translation into a second language;
b) computer code for translating the information into the second language; and
c) computer code for editing the translated information to conform the translated information with grammatical rules of the second language.

18. The computer program product of claim 17, wherein English is the first language and Chinese is the second language.

19. The computer program product of claim 17, wherein editing information in the first language to prepare the information for translation into the second language comprises: rewording at least one of idioms, colloquialisms, slang and jargon in the information; identifying one or more words in the information that have a plurality of definitions; selecting one of the definitions for each identified word; and deleting one or more words in the information that do not have a corresponding translation in the second language.

20. The computer program product of claim 17, wherein editing the translated information to conform the translated information with grammatical rules of the second language comprises: transposing one or more words in the translated information to conform the translated information with grammatical rules of the second language; and adding one or more words to the translated information to conform the translated information with grammatical rules of the second language.
